(19) United States
(12) Patent Application Publication
(10) Pub. No.: US 2023/0303306 A1
(43) Pub. Date: Sep. 28, 2023

(54) Mixing Bottle Assembly

(71) Applicant: Spiro Douvris, Lake Forest, IL (US)

(72) Inventor: Spiro Douvris, Lake Forest, IL (US)

(21) Appl. No.: 17/702,066

(22) Filed: Mar. 23, 2022

(51) Int. Cl. B65D 81/32; B65D 43/02; A47J 43/27; B01F 33/501

(52) U.S. Cl. CPC B65D 81/3216; B65D 43/0231; A47J 43/27; B01F 33/50111; B01F 2101/14

(57) ABSTRACT

A mixing bottle assembly includes a beverage bottle which contains a predetermined amount of a first ingredient. A cap is removably attachable to the beverage bottle. A tube is provided which contains a second ingredient. The tube is removably disposed on the cap such that the tube extends into the beverage bottle. Additionally, the tube is comprised of a fluid impermeable material thereby inhibiting the second ingredient from mixing with the first ingredient. The tube is removable from the cap when the cap is removed from the beverage bottle thereby facilitating the second ingredient to be poured into the beverage bottle to mix the second ingredient with the first ingredient.

### (b) CROSS-REFERENCE TO RELATED APPLICATIONS

Not Applicable

### (c) Statement Regarding Federally Sponsored Research or Development

Not Applicable

### (d) the Names of the Parties to a Joint Research Agreement

Not Applicable

### (e) Incorporation-by-Reference of Material Submitted on a Compact Disc or as a Text File Via the Office Electronic Filing System

Not Applicable

### (f) Statement Regarding Prior Disclosures by the Inventor or Joint Inventor

Not Applicable

### (g) Background of the Invention

### (1) Field of the Invention

The disclosure relates to mixing devices and more particularly pertains to a new mixing device for mixing a first ingredient with a second ingredient in a beverage bottle. The device includes a beverage bottle that contains a first ingredient. The device includes a cap that is attachable to the beverage bottle and a tube that is removably disposed on the cap. The tube contains a second ingredient and the tube extends into the beverage bottle when the cap is attached to the beverage bottle. The second ingredient is poured out of the tube and into the beverage bottle when the cap is removed from the beverage bottle.

### (2) Description of Related Art Including Information Disclosed Under 37 CFR 1.97 and 1.98

The prior art relates to mixing devices including a beverage bottle which a cork that includes a first portion engages the beverage bottle and a second portion which engages a tube such that the tube extends into the beverage bottle when the cork is inserted into the beverage bottle. The prior art discloses a drinking glass and an axial sleeve that threadably engages a receiver in the drinking glass and a tube that is positioned within the axial tube. The prior art discloses a mixing container that includes a tube that is suspended from a support in a neck of a bottle. The prior art discloses a beverage bottle, a cup that is suspended from a neck of the beverage bottle and a cap that closes the beverage bottle. The prior art discloses a beverage bottle which has a receiver integrated into a bottle wall of the bottle and a tube that slidably engages the receiver. The prior art discloses a fluid bottle and a cap that has a first portion and a second portion. The first portion threadably engages the fluid bottle and a tube frictionally engages the second portion for suspending a tube in the fluid bottle.

### (h) Brief Summary of the Invention

An embodiment of the disclosure meets the needs presented above by generally comprising a beverage bottle which contains a predetermined amount of a first ingredient. A cap is removably attachable to the beverage bottle. A tube is provided which contains a second ingredient. The tube is removably disposed on the cap such that the tube extends into the beverage bottle. Additionally, the tube is comprised of a fluid impermeable material thereby inhibiting the second ingredient from mixing with the first ingredient. The tube is removable from the cap when the cap is removed from the beverage bottle thereby facilitating the second ingredient to be poured into the beverage bottle to mix the second ingredient with the first ingredient.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a mixing bottle assembly according to an embodiment of the disclosure.

FIG. 2 is a front phantom view of an embodiment of the disclosure.

FIG. 3 is a bottom view of an embodiment of the disclosure.

FIG. 4 is an exploded cross sectional view taken along line 4-4 of FIG. 3 of an embodiment of the disclosure.

FIG. 5 is a perspective in-use view taken along line 4-4 of FIG. 3 of an embodiment of the disclosure showing a second ingredient being poured into a first ingredient.

FIG. 6 is a perspective in-use view of an embodiment of the disclosure showing a beverage bottle being shaken.

### (J) DETAILED DESCRIPTION OF THE INVENTION

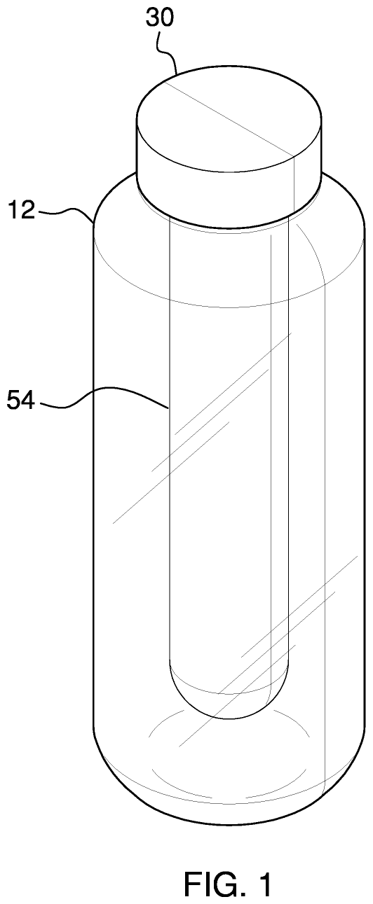

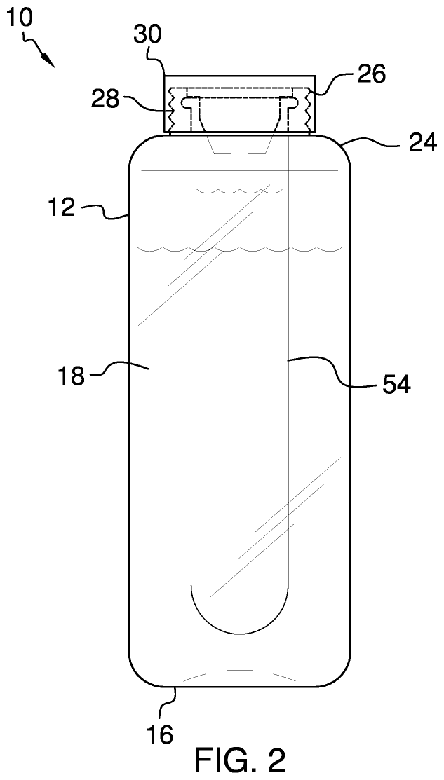

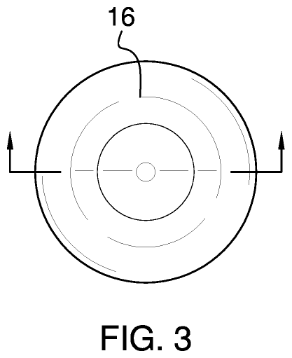

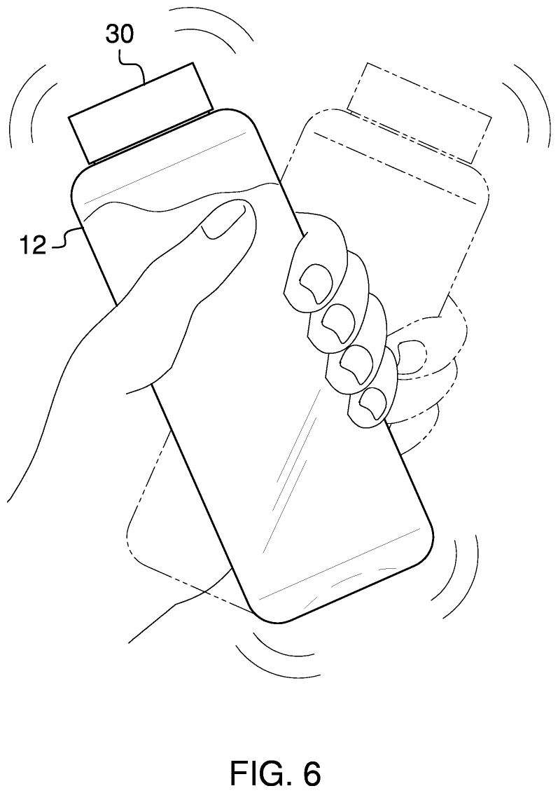

With reference now to the drawings, and in particular to FIGS. 1 through 6 thereof, a new mixing device embodying the principles and concepts of an embodiment of the disclosure and generally designated by the reference numeral 10 will be described.

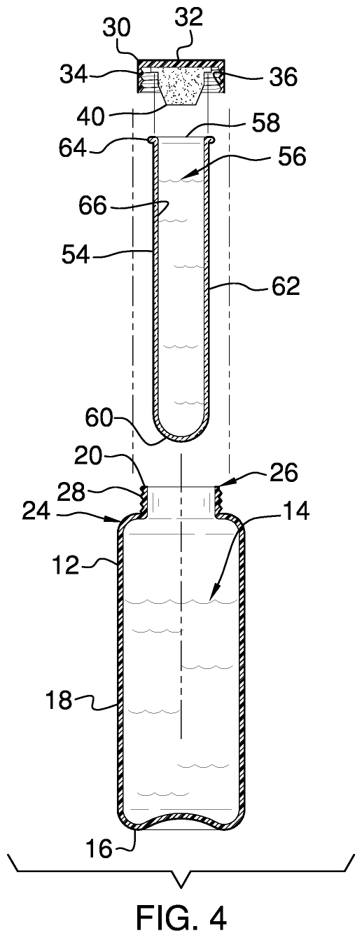

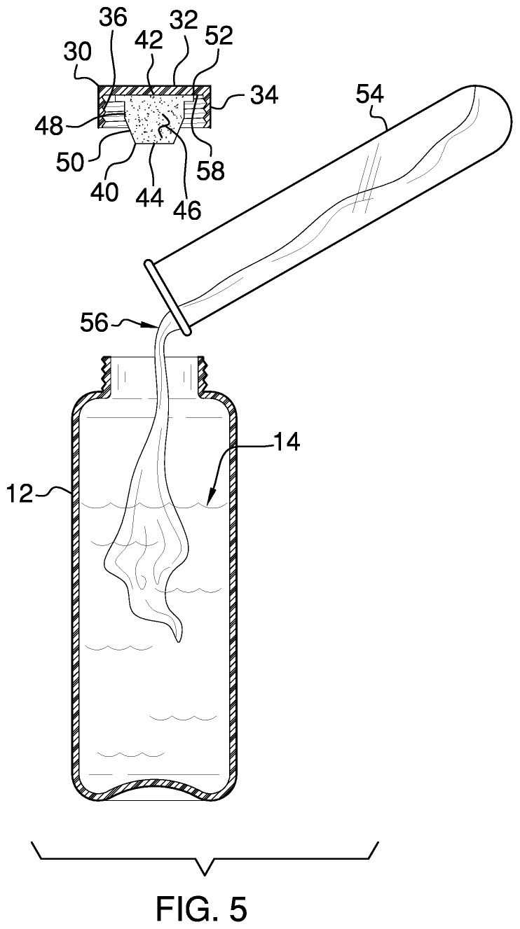

As best illustrated in FIGS. 1 through 6, the mixing bottle assembly 10 generally comprises a beverage bottle 12 which contains a predetermined amount of a first ingredient 14. The first ingredient 14 may be a liquid beverage of any conventional design, including but not being limited to, water or a cocktail mixer. The beverage bottle 12 has a bottom wall 16 and an outer wall 18 extending upwardly from the bottom wall 16, and the outer wall 18 has a distal edge 20 with respect to the bottom wall 16 defining an opening 22 into the bottle 12. The outer wall 18 has a shoulder 24 that is positioned adjacent to the distal edge 20 to define a neck 26 extending between the shoulder 24 and the distal edge 20. The neck 26 has an outer surface 28 and the outer surface 28 is threaded. As is most clearly shown in FIGS. 4 and 5, the bottom wall 16 curves upwardly toward the distal edge 20 of the outer wall 18.

A cap 30 is provided and the cap 30 is removably attachable to the beverage bottle 12. The cap 30 has a top wall 32 and an outside wall 34 extending downwardly from the top wall 32. The outside wall 34 has an inner surface 36 and the inner surface 36 is threaded. The top wall 32 has a bottom surface 38 and the inner surface 36 threadably engages the outer surface 28 of the neck 26 such that the distal edge 20 of the bottle 12 abuts the bottom surface 38 of the top wall 32 when the cap 30 is fully seated on the neck 26.

A stopper 40 is provided which has an upper end 42, a lower end 44 and an exterior surface 46 extending between the upper end 42 and the lower end 44. The exterior surface 46 has a first portion 48 extending downwardly from the upper end 42 and the exterior surface 46 has a second portion 50 extending between the first portion 48 and the lower end 44. Furthermore, the second portion 50 angles inwardly between the first portion 48 and the lower end 44 such that the lower end 44 has a diameter that is less than a diameter of the upper end 42. The stopper 40 has a lip 52 extending outwardly from the first portion 48 and the lip 52 is aligned with the upper end 42. Additionally, the upper end 42 is bonded to the bottom surface 38 of the top wall 32 of the cap 30 and the stopper 40 is centrally positioned on the bottom surface 38 of the top wall 32. The stopper 40 may be comprised of a resiliently compressible material, including but not being limited to, cork or rubber.

A tube 54 is provided which contains a second ingredient 56. The second ingredient 56 may comprise a granular material that is water soluble, including but not being limited to protein powder. Furthermore, the second ingredient 56 may comprise a fluid that is suitable for human consumption, including but not being limited to alcohol. The tube 54 is removably disposed on the cap 30 such that the tube 54 extends into the beverage bottle 12. Additionally, the tube 54 is comprised of a fluid impermeable material thereby inhibiting the second ingredient 56 from mixing with the first ingredient 14. The tube 54 is removable from the cap 30 when the cap 30 is removed from the beverage bottle 12 thereby facilitating the second ingredient 56 to be poured into the beverage bottle 12 to mix the second ingredient 56 with the first ingredient 14.

The tube 54 has a topmost end 58, a bottommost end 60 and an exterior wall 62 extending between the topmost end 58 and the bottommost end 60. The topmost end 58 is open, the bottommost end 60 is closed and the bottommost end 60 is rounded. The tube 54 has a lip 64 extending outwardly from the exterior wall 62 and the lip 64 on the tube 54 is aligned with the topmost end 58. The stopper 40 extends into the topmost end 58 such that the first portion 48 of the exterior surface 46 of the stopper 40 frictionally engages an interior surface 66 of the exterior wall 62 to form a fluid impermeable seal between the stopper 40 and the tube 54. The lip 64 on the tube 54 abuts the lip on the stopper 40. Additionally, the tube 54 extends downwardly from the cap 30 and into the beverage bottle 12 when the cap 30 is threaded onto the neck 26 of the outer wall 18 of the beverage bottle 12.

In use, the first ingredient 14 and the second ingredient 56 are each positioned in the respective beverage bottle 12 and the tube 54 during the manufacturing process. Furthermore, the beverage bottle 12 and the tube 54 are sold in a retail environment for subsequent consumption. The cap 30 is removed from the beverage bottle 12 and the tube 54 is removed from the stopper 40. The second ingredient 56 is poured from the tube 54 into the first ingredient 14 in the beverage bottle 12. The beverage bottle 12 is shaken to fully mix the first ingredient 14 and the second ingredient 56 and the resulting mixture is consumed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A mixing bottle assembly for containing a first ingredient separately from a second ingredient thereby facilitating the first ingredient to be subsequently mixed with the second ingredient, said assembly comprising:
a beverage bottle containing a predetermined amount of a first ingredient;
a cap being removably attachable to said beverage bottle; and
a tube containing a second ingredient, said tube being removably disposed on said cap such that said tube extends into said beverage bottle, said tube being comprised of a fluid impermeable material thereby inhibiting said second ingredient from mixing with said first ingredient, said tube being removable from said cap when said cap is removed from said beverage bottle thereby facilitating said second ingredient to be poured into said beverage bottle to mix said second ingredient with said first ingredient.

2. The assembly according to claim 1, wherein:
said beverage bottle has a bottom wall and an outer wall extending upwardly from said bottom wall, said outer wall having a distal edge with respect to said bottom wall defining an opening into said bottle, said outer wall having a shoulder being positioned adjacent to said distal edge to define a neck extending between said shoulder and said distal edge, said neck having an outer surface, said outer surface being threaded;
said cap has a top wall and an outside wall extending downwardly from said top wall, said outside wall having an inner surface, said inner surface being threaded, said top wall having a bottom surface, said inner surface threadably engaging said outer surface of said neck such that said distal edge of said bottle abuts said bottom surface of said top wall when said cap is fully seated on said neck; and
said assembly includes a stopper being coupled to and extending downwardly from said cap.

3. The assembly according to claim 2, wherein said stopper has an upper end, a lower end and an exterior surface extending between said upper end and said lower end, said exterior surface having a first portion extending downwardly from said upper end, said exterior surface having a second portion extending between said first portion and said lower end, said second portion angling inwardly between said first portion and said lower end such that said lower end has a diameter being less than a diameter of said upper end.

4. The assembly according to claim 3, wherein said stopper has a lip extending outwardly from said first portion, said lip being aligned with said upper end, said upper end being bonded to said bottom surface of said top wall of said cap, said stopper being centrally positioned on said bottom surface of said top wall.

5. The assembly according to claim 3, wherein said tube has a topmost end, a bottommost end and an exterior wall extending between said topmost end and said bottommost end, said topmost end being open, said bottommost end being closed, said bottommost end being rounded, said tube having a lip extending outwardly from said exterior wall, said lip on said tube being aligned with said topmost end, said stopper extending into said topmost end such that said first portion of said exterior surface of said stopper frictionally engages an interior surface of said exterior wall to form a fluid impermeable seal between said stopper and said tube.

6. The assembly according to claim 4, wherein said tube has a lip extending outwardly from said tube, said lip on said tube abutting said lip on said stopper, said tube extending downwardly from said cap and into said beverage bottle when said cap is threaded onto said neck of said outer wall of said beverage bottle.

7. A mixing bottle assembly for containing a first ingredient separately from a second ingredient thereby facilitating the first ingredient to be subsequently mixed with the second ingredient, said assembly comprising:
a beverage bottle containing a predetermined amount of a first ingredient, said beverage bottle having a bottom wall and an outer wall extending upwardly from said bottom wall, said outer wall having a distal edge with respect to said bottom wall defining an opening into said bottle, said outer wall having a shoulder being positioned adjacent to said distal edge to define a neck extending between said shoulder and said distal edge, said neck having an outer surface, said outer surface being threaded;
a cap being removably attachable to said beverage bottle, said cap having a top wall and an outside wall extending downwardly from said top wall, said outside wall having an inner surface, said inner surface being threaded, said top wall having a bottom surface, said inner surface threadably engaging said outer surface of said neck such that said distal edge of said bottle abuts said bottom surface of said top wall when said cap is fully seated on said neck;
a stopper having an upper end, a lower end and an exterior surface extending between said upper end and said lower end, said exterior surface having a first portion extending downwardly from said upper end, said exterior surface having a second portion extending between said first portion and said lower end, said second portion angling inwardly between said first portion and said lower end such that said lower end has a diameter being less than a diameter of said upper end, said stopper having a lip extending outwardly from said first portion, said lip being aligned with said upper end, said upper end being bonded to said bottom surface of said top wall of said cap, said stopper being centrally positioned on said bottom surface of said top wall; and
a tube containing a second ingredient, said tube being removably disposed on said cap such that said tube extends into said beverage bottle, said tube being comprised of a fluid impermeable material thereby inhibiting said second ingredient from mixing with said first ingredient, said tube being removable from said cap when said cap is removed from said beverage bottle thereby facilitating said second ingredient to be poured into said beverage bottle to mix said second ingredient with said first ingredient, said tube having a topmost end, a bottommost end and an exterior wall extending between said topmost end and said bottommost end, said topmost end being open, said bottommost end being closed, said bottommost end being rounded, said tube having a lip extending outwardly from said exterior wall, said lip on said tube being aligned with said topmost end, said stopper extending into said topmost end such that said first portion of said exterior surface of said stopper frictionally engages an interior surface of said exterior wall to form a fluid impermeable seal between said stopper and said tube, said lip on said tube abutting said lip on said stopper, said tube extending downwardly from said cap and into said beverage bottle when said cap is threaded onto said neck of said outer wall of said beverage bottle.

8. A method of preparing a two ingredient beverage, the steps of the method comprising:
providing a beverage bottle containing a first ingredient;
providing a cap being threadable onto said beverage bottle for closing said beverage bottle;
providing a stopper being coupled to and extending downwardly from said cap;
providing a tube containing a second ingredient;
positioning said tube on said cap such that said stopper extends into said tube for closing said tube;
threading said cap onto said beverage bottle such that said tube extends downwardly into an interior of said beverage bottle;
removing said cap from said beverage bottle;
removing said tube from said stopper;
pouring said second ingredient out of said tube and into said first ingredient in said beverage bottle; and
shaking said beverage bottle to mix said first ingredient and said second ingredient.
